(19) United States
(12) Patent Application Publication
(10) Pub. No.: US 2005/0183269 A1
(43) Pub. Date: Aug. 25, 2005

(54) Guard for a grass trimming device

(76) Inventor: Mark W. Thompson, Ottumwa, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/784,056

(22) Filed: Feb. 20, 2004

(51) Int. Cl. B26B 29/00

(52) U.S. Cl. 30/286; 30/276

(57) ABSTRACT

A guard for a grass trimming device having a support member slidably connected to the shaft of the grass trimming device, a flexible guard member connected to and extending outwardly from the support member, and a means for adjusting the distance between the guard member and the shaft.

### BACKGROUND OF THE INVENTION

Hand held grass and weed cutters commonly use guards to prevent grass and small rocks from being projected from the rotating head of the cutter towards the individual using the trimmer. Many of these guards use a Plexiglas sheet that comes down from the shaft of the grass trimming device on some type of support member that holds the Plexiglas sheet in a permanent position.

The use of a protective skirt or a transparent material such as Plexiglas as a guard causes many problems in the art. Specifically, these guards are not flexible, making it difficult for the grass trimmer to move in and around objects found in different landscapes. Also, these guards do not allow for airflow through the guard to assist in holding the clippings against the guard. Thus, these types of guards are prone to snagging on sharp or pointed objects such as large rocks or prevent the user from trimming some areas. Furthermore, because the guard in the prior art is in a fixed position on the support member, the guard is not necessarily in the optimal position based on the terrain or various landscape obstacles. All landscapes are not flat and therefore a guard occasionally needs to be moved up or down or in or out to provide maximum protection during the trimming process. Consequently, there is a need in the art for a trimmer guard that will be sufficiently flexible to move in and around objects of different landscapes that at the same time will be able to be moved in varying directions to accommodate for trimming needs.

Therefore, it is a primary object of the present invention to provide a guard that improves upon the state of the art.

Another object of the present invention is to provide a guard that is sufficiently flexible to move in and around objects found in different landscapes and allow airflow therethrough.

Yet another object of the present invention is to provide a guard that is adjustable along the shaft of the trimmer to accommodate for different landscapes.

Still yet another object of the present invention is to provide a guard for a trimmer that is adjustable to accommodate for different landscape obstacles.

These and other objects, features, and improvement will become apparent from the specification, figures, and claims provided.

### BRIEF SUMMARY OF THE INVENTION

The present invention comprises a guard for use with a grass trimming device having a support member that is slidably secured to the shaft of the grass trimming device and a flexible guard that extends outwardly from the support member. The support member likewise being adjustable to change the distance between the guard member and the shaft of the grass trimming device.

### BRIEF DESCRIPTION OF THE DRAWINGS

FIG. 1 is a perspective view of the trimming and guard member of the present invention;

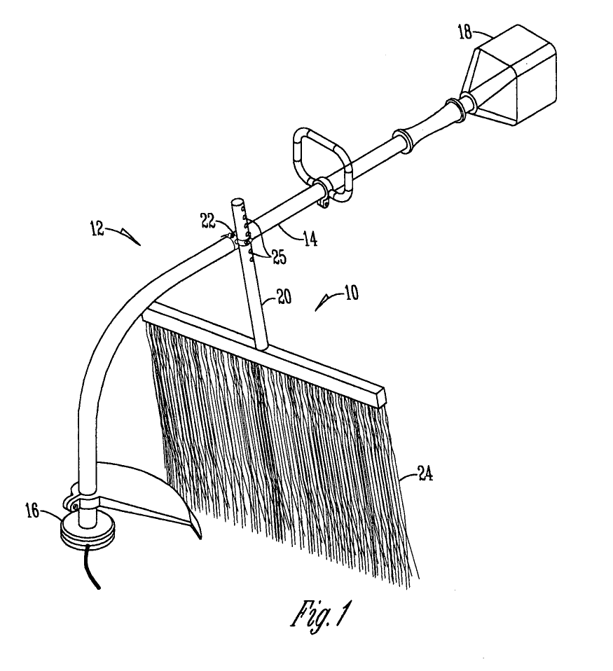

FIG. 2 is a side view of the present invention; and

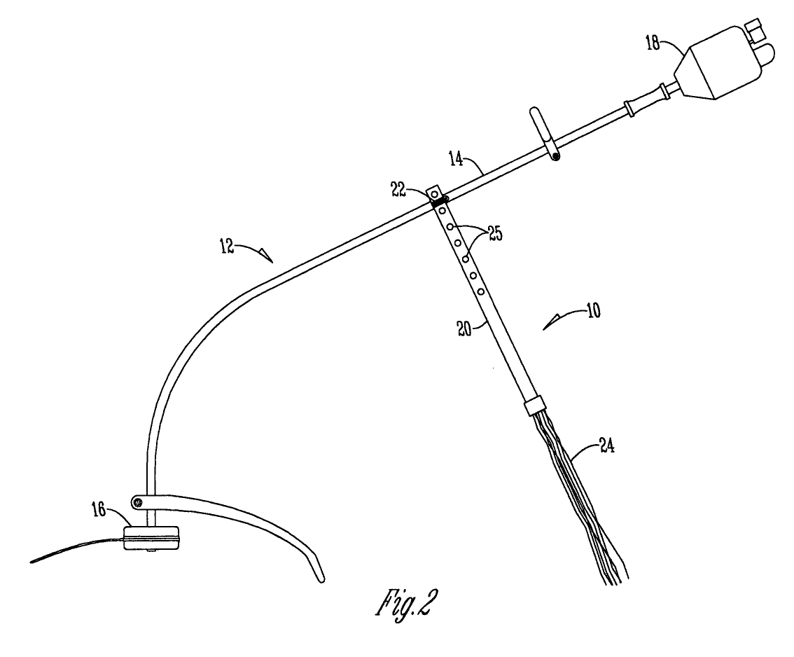

FIG. 3 is a plan view of an alternate embodiment of the invention.

### DESCRIPTION OF THE PREFERRED EMBODIMENT OF THE INVENTION

Referring to the figures, the guard 10 of the present invention is used with a conventional grass trimming device 12 having an elongated shaft 14 with a grass trimming head 16 at one end and a handle 18 at the opposite end.

The guard 10 comprises a support member 20 that is slidably connected to the shaft 14 of the grass trimming device 12. While the support member 20 can be slidably connected to the shaft 14 in any conventional manner, preferred is a releasable clamp 22 that wraps around the shaft 14 and is tightened to lock the support member 20 in place at a desired position on the shaft.

Secured to one end of the support member is a guard member 24 that extends outwardly from the support member. While the guard member 24 can be made of any material, preferred is a flexible material such as brush bristles made of synthetic, straw, or the like. Further, the guard member 24 and support member 20 extend transversely from the shaft 14 in substantially the same plane and preferably at a ninety-degree angle from the shaft 14. Also, the support member 20 has a plurality of holes 25 that extend along its length to receive the clamp 22 so that the distance from the guard member 24 to the shaft 14 can be adjusted to a desired position.

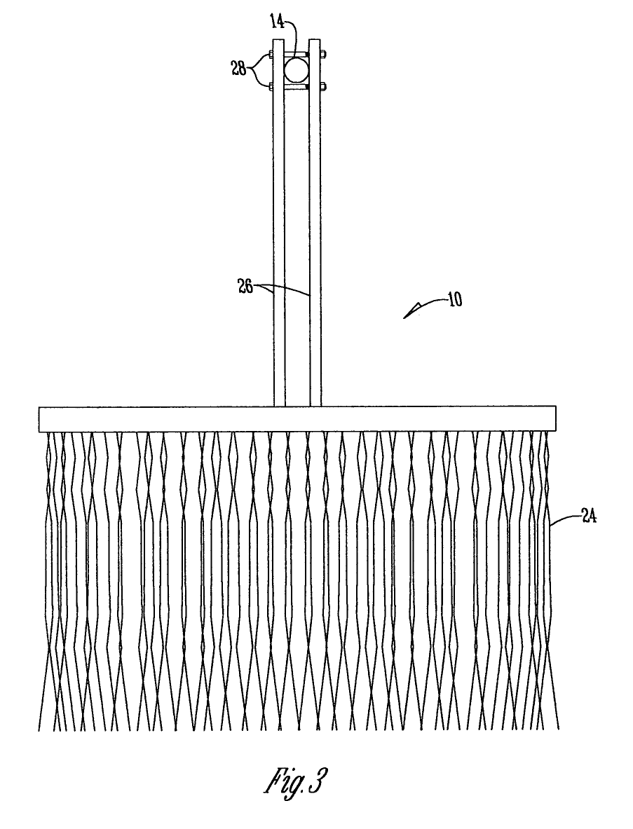

In an alternative embodiment, as shown in FIG. 3, a pair of support members 26 spaced in parallel relation are slidably connected to the shaft 14. Preferred is that the support members extend beyond the shaft 14 on opposite sides and are secured by bolts 28 that extend through the support members 26 on opposite sides of the shaft 14. The support members 26 also have a plurality of holes 25 that extend along their length to adjust the distance between the guard member 24 and the shaft 14.

In operation, the guard 10 is connected to the grass trimming device 12 by first determining the desired distance between the guard member 24 and the shaft 14. The adjustability of this distance allows flexibility in providing protection from grass trimmings and the like based on the landscape terrain and the height of the user. A shorter distance might be desired when trimming uphill, while a greater distance might be desired when trimming downhill. When the desired distance is determined, the clamp 22 is inserted through one of the holes 25 on the support member 20 and then wrapped around shaft 14.

Before tightening the clamp 22 around the shaft 14, the guard is slid to the desired position on the shaft 14. The flexibility of positioning the guard along the shaft allows a user to further adapt the guard 10 based on the landscape terrain and desired use. For example, when trimming in a fairly open area free of obstructions, the guard 10 can be positioned closer to the head 16 of the grass trimming device 12. When the area has various obstructions such as bushes and the like, the guard 10 can be positioned closer to the handle 18 to accommodate for and negotiate around the obstructions.

In addition, the guard member 24, in using a flexible material, allows for selective movement around obstacles without snagging on sharp objects. In particular, a bristle material allows airflow through the guard member 24 while restricting the flow of grass particles. A brush material also provides for the further use of sweeping grass trimmings when finished.

Accordingly, this invention provides a guard for a grass trimming device that is adjustable to accommodate varying landscape terrains and grass trimming conditions and has at least satisfied the stated objectives.

1. A guard for a grass trimming device having a shaft with a head at one end and a handle at the opposite end, comprising:
a support member slidably connected to the shaft at a first end of the support member with a releasable clamp; and
a guard member connected to and extending outwardly from a second end of the support member to deflect grass clippings projected from the head of the grass trimming device.

2. The guard of claim 1 wherein the support member has a means for adjusting the distance between the guard member and the shaft.

3. The guard of claim 1 wherein the support member further comprises a pair of support members that are spaced in parallel relation extending beyond the shaft on opposite sides of the shaft.

4. The guard of claim 1 wherein the guard member is made of flexible material.

5. The guard of claim 1 wherein the guard is positioned at a 90 degree angle to the shaft of the grass trimming device.

6. A guard for a grass trimming device having a shaft with a head at one end and a handle at the opposite end, comprising:
a support member connected to the shaft at a first end of the support member;
a guard member connected to and extending outwardly from a second end of the support member to deflect grass clippings projected from the head; and
a means for adjusting the distance between the guard member and the shaft of the grass trimming device;
wherein the guard is positioned at a 90 degree angle to the shaft.

7. The guard of claim 6 wherein the support member is slidably connected to the shaft.

8. The guard of claim 6 wherein the support member further comprises a pair of support members that are spaced in parallel relation extending beyond the shaft on opposite sides of the shaft.

9. The guard of claim 6 wherein the guard member is made of a flexible material.

10. (canceled)

11. A guard for a grass trimming device having a shaft with a head at one end and a handle at the opposite end comprising:
a support member connected to the shaft at a first end of the support member; and
a flexible brush member connected to a second end of the support member to deflect grass clippings projected from the head.

12. The guard of claim 11 wherein the support member is slidably connected to the shaft.

13. The guard of claim 11 wherein the support member has a means for adjusting the distance between the guard member and the shaft.

14. The guard of claim 11 wherein the support member further comprises a pair of support members that are spaced in parallel relation extending beyond the shaft on opposite sides of the shaft.

15. The guard of claim 11 wherein the guard member is positioned at a 90 degree angle to the shaft.

16. The guard of claim 6 wherein the adjustable means is a plurality of holes that are used to adjust the vertical distance between the guard member and the shaft.
